(19) United States
(12) Patent Application Publication
(10) Pub. No.: US 2020/0361210 A1
(43) Pub. Date: Nov. 19, 2020

(54) INFORMATION PROCESSING APPARATUS, PRINTING APPARATUS, LEARNING APPARATUS, AND INFORMATION PROCESSING METHOD

(71) Applicant: SEIKO EPSON CORPORATION, Tokyo (JP)

(72) Inventors: Katsuaki SATO, MATSUMOTO-SHI (JP); Kazunaga SUZUKI, AZUMINO-SHI (JP)

(21) Appl. No.: 15/930,505

(22) Filed: May 13, 2020

(30) Foreign Application Priority Data
May 16, 2019 (JP) 2019-092607

(51) Int. Cl. B41J 2/165; B41J 2/045; G06N 20/00

(52) U.S. Cl. CPC B41J 2/16579; G06N 20/00; B41J 2/0451

(57) ABSTRACT

An information processing apparatus includes a storage that stores a machine-learned model, an accepting section, and a processor. In the machine-learned model, machine learning has been performed according to a data set in which failure state information about a print head, use environment information about a printing apparatus, and action information representing a recommended action are associated. The accepting section accepts the failure state information about the print head and the use environment information. The processor suggests an action matching the failure according to the machine-learned model and the accepted failure state information and use environment information.

The present application is based on, and claims priority from JP Application Serial Number 2019-092607, filed May 16, 2019, the disclosure of which is hereby incorporated by reference herein in its entirety.

### BACKGROUND

### 1. Technical Field

The present disclosure relates to an information processing apparatus, a printing apparatus, a learning apparatus, an information processing method, and the like.

### 2. Related Art

Various methods of predicting an abnormality in a printing apparatus are known in related art. For example, JP-A-2015-170200 discloses a method in which test images transmitted periodically from a printing apparatus are analyzed to predict a failure according to time-series changes in analysis results.

In the method in JP-A-2015-170200, a failure is predicted according to a decision result for predetermined test images. Specifically, a score for, for example, the amount of noise is calculated from each test image, and under the assumption that scores linearly change, a score in the future is inferred. A failure is predicted according to the inference result. However, whether a failure will occur in the printing apparatus largely depends on the environment in which the printing apparatus is used. To infer an abnormality with higher precision, it is necessary to consider not only a decision result for test images but also other information such as the use environment.

### SUMMARY

One aspect of the present disclosure relates to an information processing apparatus that has: a storage that stores a machine-learned model in which machine learning was performed according to a data set in which failure state information about a print head, use environment information about a printing apparatus having the print head, and action information representing an action matching a failure in the print head are associated; an accepting section that accepts the failure state information about the print head and the use environment information; and a processor that suggests an action matching the failure according to the machine-learned model and to the failure state information and the use environment information that were accepted.

### BRIEF DESCRIPTION OF THE DRAWINGS

FIG. 1 illustrates an example of the structure of a printing apparatus.

FIG. 2 illustrates a structure around print heads.

FIG. 3 illustrates an arrangement of a plurality of print heads.

FIG. 4 also illustrates the structure around print heads.

FIG. 5 illustrates an example of the structure of an imaging section.

FIG. 6 is a cross-sectional view of the print head.

FIG. 7 is a drawing to explain a method of deciding a discharge failure according to waveform information about residual vibration.

FIG. 8 schematically illustrates the entry of a bubble.

FIG. 9 schematically illustrates an increase in the viscosity of ink.

FIG. 10 schematically illustrates the adhesion of foreign matter.

FIG. 11 illustrates waveform information about residual vibration matching a nozzle state.

FIG. 12 is a graph illustrating classification based on failure state information.

FIG. 13 illustrates nozzle complement processing.

FIG. 14 illustrates an example of the structure of a learning apparatus.

FIG. 15 illustrates a neural network.

FIG. 16 illustrates an example of training data.

FIG. 17 illustrates an example of inputs to and outputs from a neural network.

FIG. 18 illustrates an example of the structure of an information processing apparatus.

FIG. 19 illustrates another example of the structure of the information processing apparatus.

FIG. 20 is a flowchart illustrating processing in the information processing apparatus.

### DESCRIPTION OF EXEMPLARY EMBODIMENTS

An embodiment of the present disclosure will be described below. This embodiment described below does not unreasonably restrict the contents described in the scope of claims. All of the structures described in this embodiment are not always essential structural requirements.

### 1. Overview

### 1.1 Example of the Structure of a Printing Apparatus

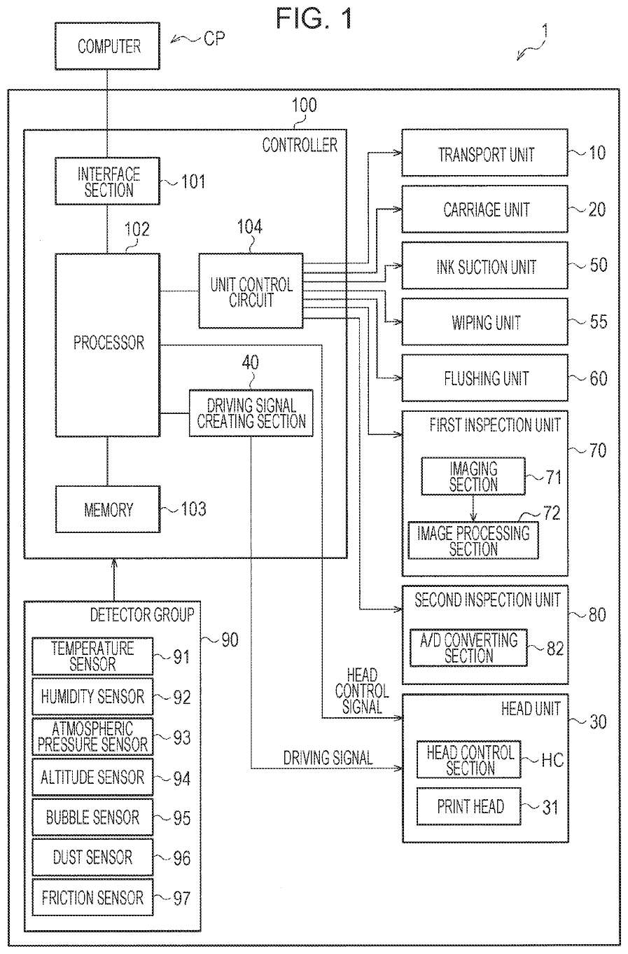

FIG. 1 illustrates an example of the structure of a printing apparatus 1 according to this embodiment. As illustrated in FIG. 1, the printing apparatus 1 includes a transport unit 10, a carriage unit 20, a head unit 30, a driving signal creating section 40, an ink suction unit 50, a wiping unit 55, a flushing unit 60, a first inspection unit 70, a second inspection unit 80, a detector group 90, and a controller 100. The printing apparatus 1 discharges ink toward a print medium such as paper, a cloth, or a film. The printing apparatus 1 is coupled to a computer CP so as to be capable of communicating with the computer CP. To have the printing apparatus 1 print an image, the computer CP transmits print data matching the image to the printing apparatus 1. The print data includes to-be-printed image data representing the image as well as print setting information according to which the size of the print medium, printing quality, colors, and the like are determined.

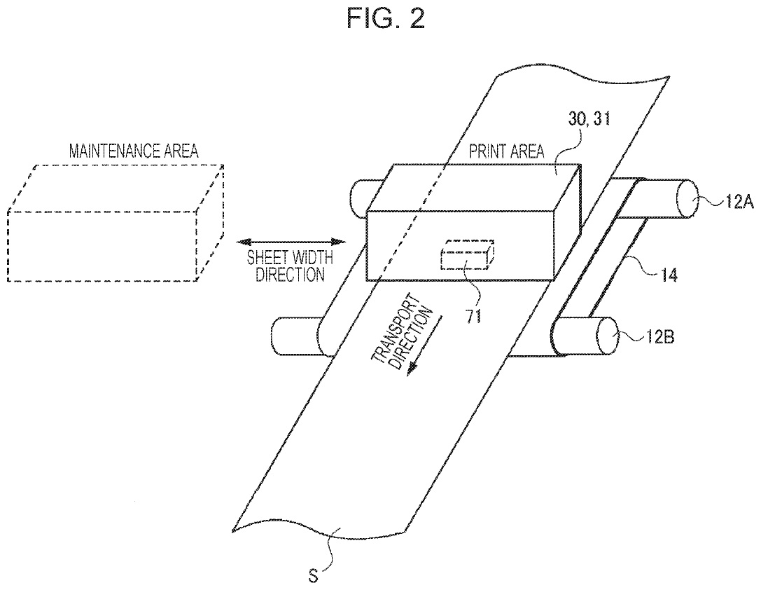

The transport unit 10 transports a print medium in a predetermined direction. The print medium is, for example, a sheet S. The sheet S may be a print sheet with a predetermined size or may be continuous paper. In the description below, the direction in which a print medium is transported will be referred to as the transport direction. The transport unit 10 has an upstream roller 12A, a downstream roller 12B, and a belt 14, as illustrated in FIG. 2. When a transport motor (not illustrated) rotates, the upstream roller 12A and downstream roller 12B rotate and the belt 14 thereby rotates. A supplied print medium is transported to a print area, in which print processing can be executed, by the belt 14. The print area opposes the head unit 30. When the belt 14 transports the sheet S, it moves in the transport direction with respect to a print head 31.

The carriage unit 20 moves the head unit 30 including the print head 31. The carriage unit 20 has a carriage supported so as to be bidirectionally movable along a guide rail in the width direction of the sheet S as well as a carriage motor. The carriage moves together with the print head 31 by being driven by the carriage motor. When the carriage moves in the sheet width direction, the print head 31, which has been positioned in the print area, moves to a maintenance area different from the print area. In the maintenance area, recovery processing can be executed.

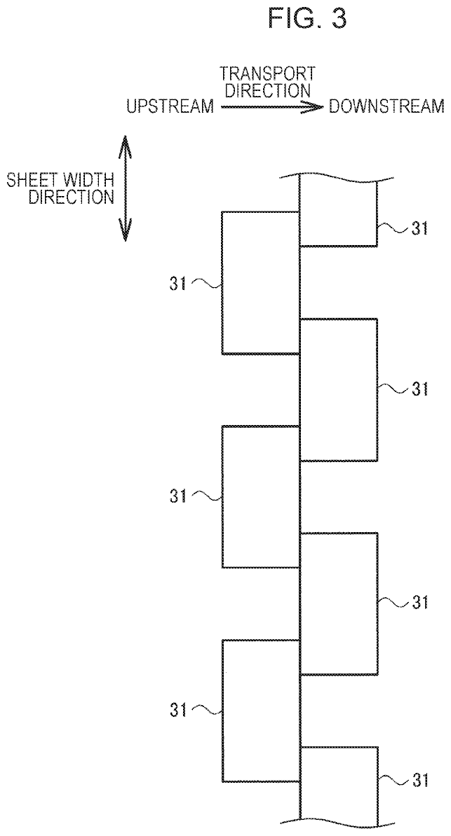

The head unit 30 discharges ink toward the sheet S that has been transported to the print area by the transport unit 10. When ink is discharged toward the sheet S by the head unit 30 while the sheet S is being transported, dots are formed on the sheet S, printing an image on the sheet S. Since the printing apparatus 1 in this embodiment is, for example, a printer in a line head method, the head unit 30 can form dots for the sheet width at one time. The head unit 30 has a plurality of print heads 31 placed in a staggered arrangement along the sheet width direction as illustrated in FIG. 3. The head unit 30 also has a head control section HC that controls the print heads 31 in response to a head control signal from the controller 100.

Each print head 31 has, for example, a black ink nozzle row, a cyan ink nozzle row, a magenta ink nozzle row, and a yellow ink nozzle row on the bottom surface of the print head 31. Different nozzle rows discharge inks in different colors toward the sheet S. The print head 31 in this embodiment may have nozzle rows only in a particular ink color. In practice, nozzles are at different positions in the transport direction as illustrated in FIG. 3. When timings at which to discharge ink are varied, however, nozzles constituting nozzle rows in each print head 31 can be thought to be arranged in a row.

When ink droplets are non-continuously discharged from each nozzle to a sheet S while it is being transported, nozzles form raster lines on the sheet S. For example, a first nozzle forms a first raster line on the sheet S, and a second nozzle forms a second raster line on the sheet S. In the description below, the direction of the raster line will be referred to as the raster direction.

When a discharge failure occurs in a nozzle, an appropriate dot is not formed on the sheet S. A discharge failure represents a state in which an ink droplet is not appropriately discharged due to clogging in a nozzle. In the description below, a dot that has not been appropriately formed will be referred to as a failed dot. Once a discharge failure occurs in a nozzle, it hardly recovers autonomously from the discharge failure, so discharge failures occur in succession. Then, failed dots occur in succession on the sheet S in the raster direction. On the printed image, therefore, failed dots are observed as a white or bright stripe.

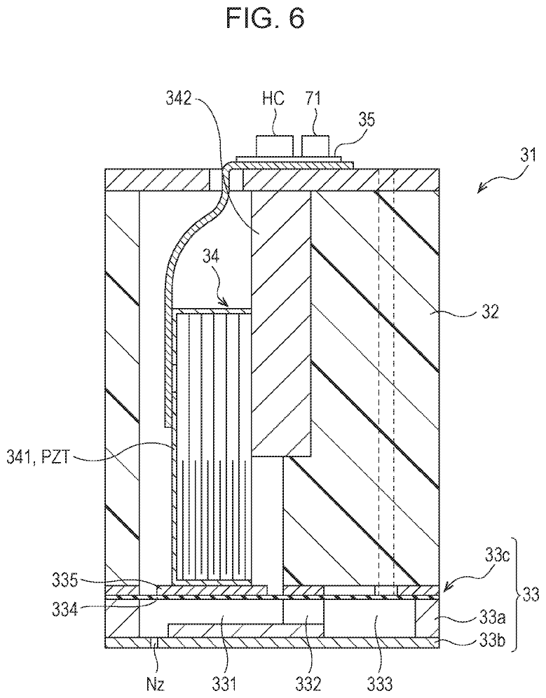

The driving signal creating section 40 creates a driving signal. When a driving signal is applied to a piezoelectric element PZT, which is a driving element, the piezoelectric element PZT expands and contracts, changing the volume of a pressure chamber 331 corresponding to the relevant nozzle Nz. A driving signal is applied to the print head 31 during print processing, processing to detect a discharge failure by using the second inspection unit 80, flushing processing, or the like. A specific example of the print head 31 including piezoelectric elements PZT will be described later with reference to FIG. 6.

The ink suction unit 50 sucks ink in the print head 31 from the nozzles Nz in it and expels the ink to the outside of the print head 31. In a state in which a cap (not illustrated) is placed in tight contact with the nozzle surface of the print head 31, the ink suction unit 50 operates a suction pump (not illustrated) to generate negative pressure in space inside the cap and suck ink in the print head 31 together with a bubble that has entered the interior of the print head 31. Thus, the nozzle Nz can recover from the discharge failure.

The wiping unit 55 removes foreign matter, such as paper dust, adhering to the nozzle surface of the print head 31. The wiping unit 55 has a wiper that can abut the nozzle surface of the print head 31. The wiper is formed from an elastic member having flexibility. When the carriage is driven by the carriage motor and moves in the sheet width direction, the end of the wiper abuts the nozzle surface of the print head 31, warps, and cleans the nozzle surface. Thus, the wiping unit 55 removes foreign matter, such as paper dust, adhering to the nozzle surface, making it possible to normally discharge ink from the nozzle Nz that has been clogged with the foreign matter.

The flushing unit 60 accepts ink discharged due to a flushing operation by the print head 31, and holds the ink. In the flushing operation, a driving signal not related to an image to be printed is applied to a driving element to forcibly discharge ink droplets from the nozzle Nz in succession. This can restrain ink from becoming more viscous or drying and thereby failing to be discharged by an appropriate amount, so the nozzle Nz can recover from the discharge failure.

The first inspection unit 70 checks for a discharge failure according to the state of the printed image formed on the sheet S. The first inspection unit 70 includes an imaging section 71 and an image processor 72. In FIG. 1, the image processor 72 and controller 100 are separately provided. However, the image processor 72 may be implemented by the controller 100. The imaging section 71 and processing in the image processor 72 will be described later in detail.

The second inspection unit 80 checks for a discharge failure for each nozzle Nz according to the state of ink in the print head 31. The second inspection unit 80 includes an analog-to-digital (A/D) converting section 82. The A/D converting section 82 performs A/D conversion on a detection signal in the piezoelectric element PZT and outputs a digital signal. The detection signal referred to here is waveform information about residual vibration. In this embodiment, a digital signal resulting from A/D conversion will be also described as waveform information about residual vibration. Waveform information about residual vibration and a method of detecting a discharge failure according to the waveform information about residual vibration will be described later with reference to FIGS. 6 to 11.

The controller 100 is a control unit that controls the printing apparatus 1. The controller 100 includes an interface section 101, a processor 102, a memory 103, and a unit control circuit 104. The interface section 101 transmits data and receives data between the printing apparatus 1 and the computer CP, which is an external apparatus. The processor 102 is an arithmetic processing apparatus that controls the whole of the printing apparatus 1. The processor 102 is, for example, a central processing unit (CPU). In the memory 103, an area to store programs for the processor 102, a working area, and the like are allocated. According to the programs stored in the memory 103, the processor 102 causes the unit control circuit 104 to control units.

The detector group 90 monitors a situation in the printing apparatus 1. The detector group 90 includes, for example, a temperature sensor 91, a humidity sensor 92, an atmospheric pressure sensor 93, an altitude sensor 94, a bubble sensor 95, a dust sensor 96, and a friction sensor 97. The altitude sensor 94 is implemented by, for example, a combination of a temperature sensor and an atmospheric pressure. A sensor that implements the altitude sensor 94 may be, for example, the temperature sensor 91 and atmospheric pressure sensor 93 or may be a different sensor. The detector group 90 may include members (not illustrated) such as a rotary encoder used in control of the transport of a print medium or the like, a paper detection sensor that detects whether a print medium to be transported is present, and a linear encoder that detects the position of the carriage in its movement direction.

So far, the printing apparatus 1 in a line head method in which print heads 31 are provided so as to cover the sheet width has been described. However, the printing apparatus 1 in this embodiment is not limited to a line head method, but may be a printing apparatus in a serial head method. In the serial head method, the print head 31 is bidirectionally moved in the main scanning direction to perform printing across the paper width.

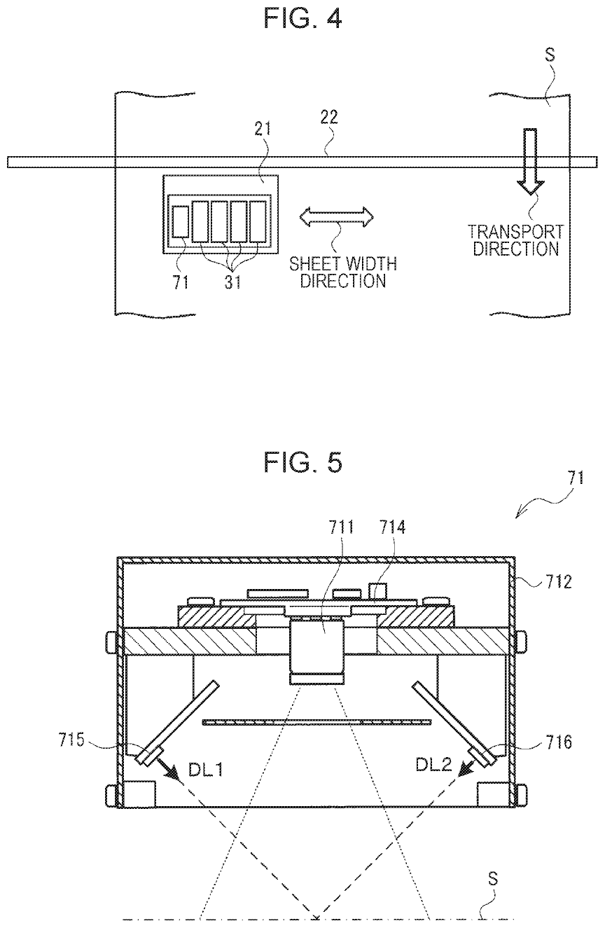

FIG. 4 is a plan view schematically illustrating the structure of the periphery of print heads 31 in the printing apparatus 1 in a serial head method. Each print head 31, which has a plurality of nozzles Nz, ejects ink from the nozzles Nz toward the print medium in response to a command from the processor 102, forming an image on the print medium. As illustrated in FIG. 4, a plurality of print heads 31 are mounted on a carriage 21. When inks in four colors are used as an example, one print head 31 is provided for ink in each color.

The print heads 31 and imaging section 71 are mounted on the carriage 21. The carriage 21 moves the print heads 31 and imaging section 71 in the sheet width direction. The sheet width direction may also be referred to as the main scanning direction. The carriage 21 is moved along a carriage rail 22 by a driving source (not illustrated) and a transmission apparatus (not illustrated). The carriage 21 is driven in response to a carriage control signal that the carriage 21 has received from the processor 102.

During printing, ink is discharged from the print heads 31 moved by the carriage 21 in the sheet width direction toward the sheet S transported in the transport direction, as illustrated in FIG. 4. As a result, an image is formed on the sheet S. The print medium is transported by the transport unit 10 as in the line head method.

### 1.2 First Inspection Unit

FIG. 5 illustrates an example of the structure of the imaging section 71 included in the first inspection unit 70. Specifically, FIG. 5 is a longitudinal cross-sectional view illustrating the structure of the interior of the imaging section 71. In the imaging section 71, an imaging unit 711, a control board 714, a first light source 715, and a second light source 716 are mounted in a case 712 in a box-like shape, the case 712 having an opening at the bottom. However, the structure of the imaging section 71 is not limited to the structure in FIG. 5.

The first light source 715 and second light source 716 are N light sources, N being equal to or larger than 2, that emit light for use for photography to a subject eligible for imaging. The first light source 715 and second light source 716 are positioned so that light emitted in their light emitting front directions DL1 and DL2 is regularly reflected at the subject. The first light source 715 and second light source 716 are each, for example, a white light emitting diode. A voltage and current supplied for driving are controlled by the control board 714 to control the amount of light.

The imaging unit 711 includes a lens and an imaging element. The imaging unit 711 is disposed so that its optical axis is directed toward a reflection position at which light from the first light source 715 and light from the second light source 716 are regularly reflected and that the imaging unit 711 is at a predetermined distance from the print medium, which is a subject.

As described above with reference to FIGS. 2 and 4, the imaging section 71 is disposed in the vicinity of the print heads 31. The printing apparatus 1 in a line head method does not need to move the head unit 30 in the sheet width direction during printing, so high-speed printing is possible. However, it is assumed that the imaging section 71 is not moved during printing. To perform imaging across the sheet width, therefore, the imaging section 71 desirably has a wide angle of view or a plurality of imaging sections 71 are desirably disposed. When the printing apparatus 1 is in a serial head method, the imaging section 71 is also moved during printing along with the driving of the carriage 21. This is advantageous in that when imaging is performed a plurality of times while the carriage 21 is being bidirectionally driven, imaging across the sheet width is easily performed. In this embodiment, either a line head method or a serial head method may be used. In the description below, it will be assumed that printed matter is appropriately imaged by the imaging section 71.

When, for example, the printing apparatus 1 is in a line head method, a nozzle group composed of nozzle rows of a plurality of print heads 31 can be thought as nozzles Nz arranged in a row, as described above. In preliminary design, therefore, a relationship is known between the position of a given nozzle Nz in the nozzle group and a position at which ink discharged from the given nozzle Nz is landed on the print medium. This relationship between the position of the nozzle Nz and the landing position is also known in the printing apparatus 1 in a serial head method as well. Captured image data resulting from the imaging of a print result by the imaging section 71 is predicted to become an image created by enlarging or reducing to-be-printed image data used in the printing at a predetermined magnification ratio. The predetermined magnification ratio referred to here is information that can be calculated from design parameters such as a nozzle interval, a transport pitch for the print medium, the resolution of the imaging element, and the lens structure of the imaging section 71.

The image processor 72 creates reference data with the same resolution as captured image data by performing scaling processing on to-be-printed image data at the predetermined magnification ratio. The image processor 72 compares the captured image data with the reference data to detect a discharge failure in the nozzle Nz.

Specifically, the controller 100 in the printing apparatus 1 starts print processing for the sheet S according to the to-be-printed image data received from the computer CP. The imaging section 71 takes a picture of the image printed on the sheet S concurrently with the print processing.

The image processor 72 acquires to-be-printed image data from the computer CP and edits the to-be-printed image data to create reference data. The image processor 72 calculates a difference in pixel value for each pixel between the captured image data and the reference data, and decides whether there is a failed dot position for each color according to the calculated difference in pixel value. The failed dot position represents a position at which a dot is not appropriately formed on the print medium due to the inability to discharge ink from the nozzle Nz. Specifically, the image processor 72 decides that there is no failed dot position when the difference in pixel value is equal to or smaller than a predetermined value and that there is a failed dot position when the difference in pixel value exceeds the predetermined value. Therefore, by making a decision about a failed dot according to the captured image, it can be decided whether there is a failed dot for each of a plurality of nozzles Nz.

### 1.3 Second Inspection Unit

FIG. 6 is a cross-sectional view of the print head 31. The print head 31 includes a case 32, a flow path unit 33, and a piezoelectric element unit 34. The case 32 is a member in which piezoelectric elements PZT and the like are accommodated and are fixed. The case 32 is manufactured from, for example, a non-conductive resin material such as an epoxy resin.

The flow path unit 33 has a flow path forming substrate 33a, a nozzle palate 33b, and a vibration plate 33c. The nozzle palate 33b is joined to one surface of the flow path forming substrate 33a, and the vibration plate 33c is joined to the other surface. In the flow path forming substrate 33a, a pressure chamber 331, an ink supply path 332, and a common ink chamber 333 are formed, which are used as hollows and a groove. The flow path forming substrate 33a is manufactured from, for example, a silicon substrate. In the nozzle palate 33b, a nozzle group composed of a plurality of nozzles Nz is provided. The nozzle palate 33b is manufactured from a conductive plate-like member such as, for example, a thin metal plate. A diaphragm 334 is provided at a portion opposite to each pressure chamber 331 in the vibration plate 33c. The diaphragm 334 is deformed by the piezoelectric element PZT, changing the volume of the pressure chamber 331. Since the vibration plate 33c, an adhesive, and the like are present between the piezoelectric element PZT and the nozzle palate 33b, the piezoelectric element PZT and nozzle palate 33b are electrically insulated from each other.

The piezoelectric element unit 34 has a piezoelectric group 341 and a fixing plate 342. The piezoelectric group 341 is shaped like a comb. Each tooth of the comb is one piezoelectric element PZT. The end face of each piezoelectric element PZT is bonded to an island portion 335, which is part of the diaphragm 334 opposite to the piezoelectric group 341. The fixing plate 342 supports the piezoelectric group 341. The case 32 is attached to the fixing plate 342. The piezoelectric element PZT is an example of an electromechanical conversion element. When a driving signal is applied to the piezoelectric element PZT, it expands and contracts in the longitudinal direction, causing a change in pressure in the liquid in the pressure chamber 331. Due to a change in the volume of the pressure chamber 331, the ink in the pressure chamber 331 undergoes a change in pressure. This change in pressure can be used to discharge the ink from the nozzle Nz. A structure may be used by which a bubble is generated according to an applied driving signal to discharge an ink droplet, instead of using the piezoelectric element PZT as an electromechanical conversion element.

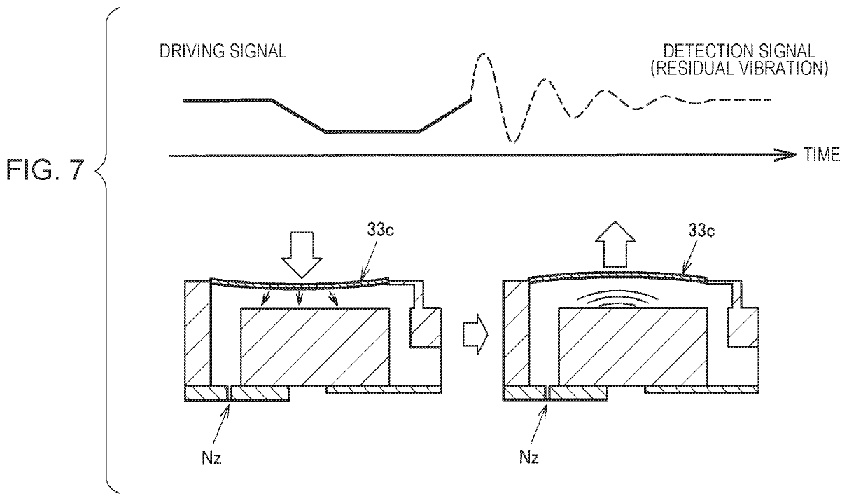

FIG. 7 illustrates the principle of the detection of a discharge failure by the second inspection unit 80. As illustrated in FIG. 7, when a driving signal is applied to the piezoelectric element PZT, it warps and the vibration plate 33c thereby vibrates. Even when the application of the driving signal to the piezoelectric element PZT is stopped, there is residual vibration in the vibration plate 33c. When the vibration plate 33c vibrates due to the residual vibration, the piezoelectric element PZT vibrates according to the residual vibration in the vibration plate 33c and outputs a signal. Therefore, by generating residual vibration in the vibration plate 33c and detecting a signal generated in the piezoelectric element PZT at that time, the property of each piezoelectric element PZT can be determined. Information based on the waveform of a signal generated in the piezoelectric element PZT due to residual vibration will be referred to as residual vibration waveform information or a waveform pattern.

A detection signal matching residual vibration in the piezoelectric element PZT is entered to the second inspection unit 80. The A/D converting section 82 in the second inspection unit 80 performs A/D conversion processing on the detection signal, and outputs waveform information, which is digital data. The waveform information is stored in the memory 103 and is used in learning processing and inference processing, which will be described later. The second inspection unit 80 may include a noise reduction section (not illustrated) and the like. Waveform information output from the second inspection unit 80 is not limited to a waveform itself, but may be information related to a cycle or amplitude. The second inspection unit 80 may also decide whether there is a discharge failure for each nozzle Nz, according to the cycle or amplitude. The waveform information referred to here includes a decision result indicating normality or abnormality. In this case, the second inspection unit 80 includes a waveform shaping section (not illustrated) and a measuring section (not illustrated) such as a pulse width detection section.

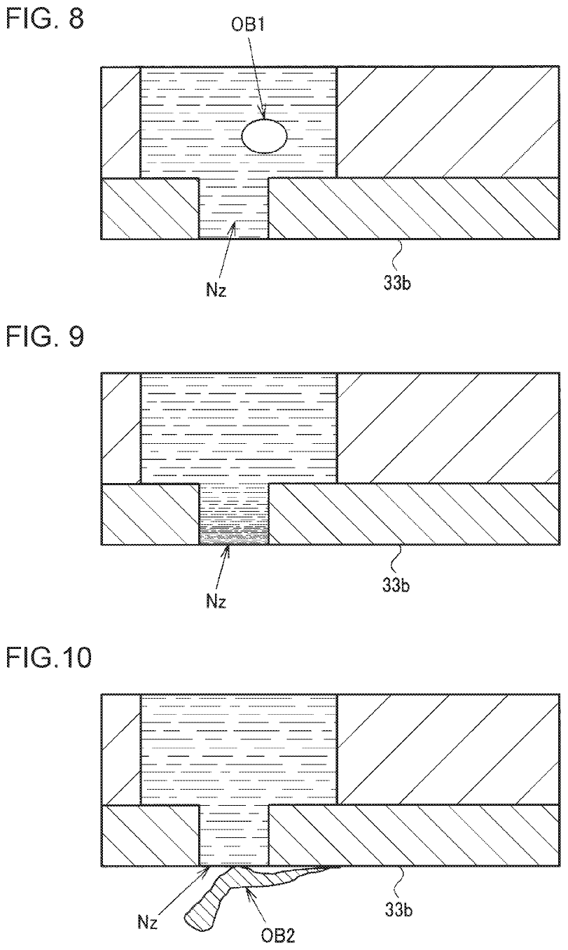

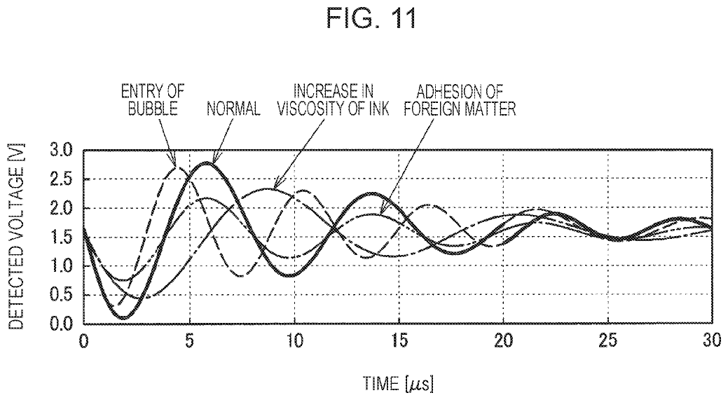

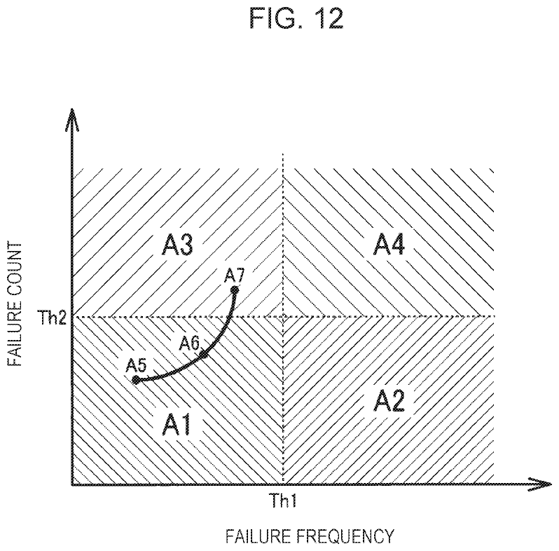

FIGS. 8 to 10 exemplify discharge failure factors. FIG. 11 illustrates waveform information about residual vibration matching the state of the nozzle Nz. FIG. 8 schematically illustrates a state in which a bubble has entered the interior of the print head 31. In FIG. 8, OB1 indicates a bubble. When a bubble enters the interior of the print head 31, the waveform of residual vibration has a shorter cycle than a waveform in the normal state, as illustrated in FIG. 11. FIG. 9 schematically illustrates a state in which the viscosity of ink in the print head 31 has increased. Increased viscosity represents a state in which the viscosity of ink is higher than in the normal state. When the viscosity of ink increases, the waveform of residual vibration has a longer cycle than a waveform in the normal state, as illustrated in FIG. 11. FIG. 10 schematically illustrates a state in which foreign matter has attached to the nozzle surface, which is the bottom surface of the print head 31. In FIG. 10, OB2 indicates foreign matter such as paper dust. When foreign matter attaches to the nozzle surface, the waveform of residual vibration has a lower amplitude than a waveform in the normal state, as illustrated in FIG. 11. As describe above, when a decision is made on waveform information about residual information, inspection for a discharge failure is possible.

### 1.4 Method in this Embodiment

A method of detecting a failure in the print head 31 is known as described above for the first inspection unit 70 and second inspection unit 80. A failure in the print head 31 is specifically a discharge failure in the nozzle Nz. In this embodiment, it is only necessary to be able to detect a failure in the print head 31. Any one of the first inspection unit 70 and second inspection unit 80 may be omitted from the printing apparatus 1. Alternatively, a third inspection unit may be added that detects a failure in the print head 31 by a different method.

FIG. 12 is a graph illustrating classification based on failure state information about the print head 31. Failure state information represents the state of the nozzles Nz. Specifically, failure state information represents the degree of failures. Failure state information includes failure count information about the nozzles Nz and failure frequency information about the nozzles Nz, for example. Failure count information represents the number of nozzles Nz decided to be faulty in one failure decision. Failure frequency information represents a frequency at which a nozzle failure occurs. For example, failure frequency information represents the number of times a nozzle failure was detected in a given period. Alternatively, failure frequency information may represent a duration during which no nozzle failure occurred, that is, a time during which continuous printing is possible without a nozzle failure.

The horizontal axis in FIG. 12 represents failure frequency information; the failure frequency is higher at a more right position on the horizontal axis. The vertical axis in FIG. 12 represents failure count information; the failure count is higher at an upper position on the vertical axis. When a threshold Th1 is set in failure frequency information and a threshold Th2 is set in failure count information as illustrated in FIG. 12, a two-dimensional plane is divided into four areas A1 to A4.

A1 in FIG. 12 is an area in which the nozzle failure frequency is low and, even when nozzle failures occur, the failure count is low. When failure state information at a given timing is plotted in A1, therefore, appropriate printing is possible any action does not need to be taken.

A2 in FIG. 12 is an area in which the nozzle failure frequency is high. When failure state information is plotted in A2, therefore, stable printing is difficult. However, the failure count in one failure decision is small. In the area A2, therefore, it is desirable to perform nozzle complement processing as an action. In nozzle complement processing, a failed dot caused by a failure in a given nozzle Nz is complemented by using another nozzle Nz.

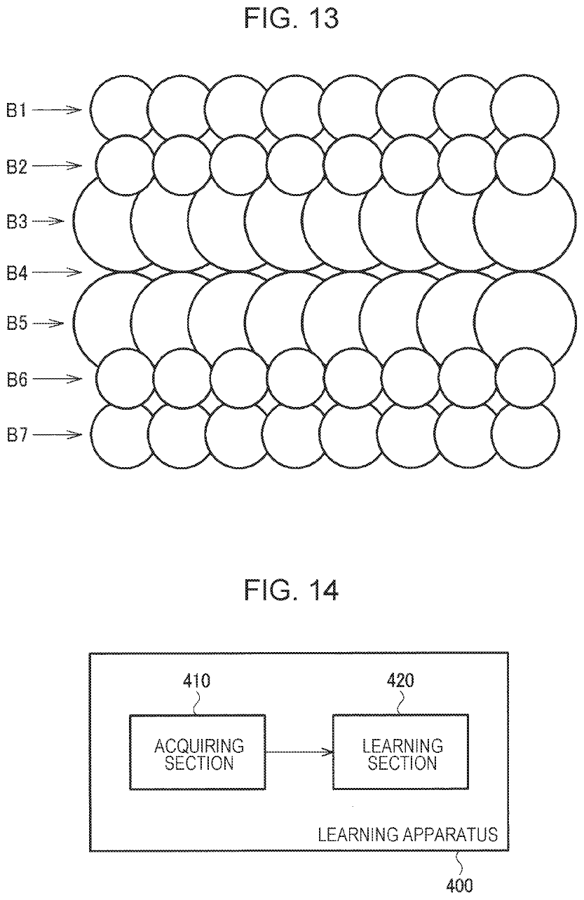

FIG. 13 schematically illustrates nozzle complement processing. In FIG. 13, an example is illustrated in which each of a plurality of nozzles Nz forms a plurality of dots in the horizontal direction to print an image on a print medium. B1 to B7 respectively represent a horizontal position at which dots are formed by a first nozzle to a seventh nozzle. In the example in FIG. 13, a discharge failure has occurred in the fourth nozzle and no dot is formed at the position indicated by B4. When nozzle complement processing is not performed, therefore, a horizontal stripe is generated. In view of this, nozzle complement processing is performed in which the amount of ink discharged from the third nozzle and fifth nozzle, which are adjacent to the fourth nozzle, is increased. As a result, dots at the positions indicated by B3 and B5 are enlarged as illustrated in FIG. 13, so it is possible to prevent the stripe from becoming noticeable. In nozzle complement processing, processing is also performed to reduce the amount of ink discharged from the second nozzle adjacent to the third nozzle and from the sixth nozzle adjacent to the fifth nozzle so that dot sizes are well balanced. When the failure count is small, it is possible to suppress a drop in printing quality by using peripheral nozzles Nz to perform complement processing as illustrated in FIG. 13. Nozzle complement processing is not limited to adjacent complement illustrated in FIG. 13. Various other methods are known. In this embodiment, these methods can be widely applied.

A3 in FIG. 12 is an area in which the failure count is large. Since a plurality of nozzles Nz cause a failure together, it is difficult to maintain printing quality by nozzle complement processing. However, the nozzle failure frequency is low, so it is thought that these nozzle failures are sporadic. When the current failures are eliminated, therefore, it may be possible to continue printing. In the area A3, therefore, it is desirable to perform cleaning as an action. Cleaning is an operation to clean the interior of the print head 31 by ink suction by the ink suction unit 50. Recovery processing other than cleaning may be performed in the area A3. Recovery processing is, for example, wiping by the wiping unit 55 or flushing by the flushing unit 60.

A4 in FIG. 12 is an area in which the failure count is large and the failure frequency is high. The high failure count makes it difficult to maintain printing quality by nozzle complement processing. The high failure frequency results in a high probability that even when recovery processing is performed, a failure occurs again. In the area A4, therefore, it is desirable to replace the print head 31 as an action.

As described above, an appropriate action can be inferred according to failure state information at a given timing. Since an action is taken after the occurrence of a discharge failure, however, it is difficult to suppress waster paper. Specifically, printed matter produced from when a discharge failure occurs until the discharge failure is eliminated by taking an action becomes waste paper, which is unusable printed matter. Here, waste paper particularly represents printed matter that does not reach the level of demanded printing quality due to improper ink discharging from the print head 31. When a business-use printer or the like produces printed matter with low quality, the printed matter cannot be used as commercial products. The generation of waste paper leads to a large loss.

It would be possible to infer the position of a future plot, that is, to predict a future failure and take an action in advance by analyzing the positions of plots in the two-dimensional plane illustrated in FIG. 12. When, for example, a plot at a given timing is at A5 and then moves to A6, it is predicted that the plot will moves to the position indicated by A7. In this case, when nozzle complement processing is started before the plot moves to A7, in a narrow sense, before the plot reaches the area indicated by A3, it is possible to suppress waste paper.

However, it is known that failures in the print head 31 are concerned with various factors related to the environment in which the printing apparatus 1 is used. For example, possible factors that raise the failure frequency are the degree of the contamination of air, temperature, and the like. Possible factors that increase the failure count are a bubble in ink, a fluffy print medium, and the like. The environment in which the printing apparatus 1 is used varies with time. When only failure state information is used, therefore, it is difficult to highly precisely predict a failure state in the future or an appropriate action. In other words, even when transition of a plot is predicted on the two-dimensional plane in FIG. 12, prediction with sufficient precision is difficult.

In this embodiment, therefore, processing to predict a recommended action is performed by performing machine learning in which failure state information, use environment information about the printing apparatus 1, and action information are used. In machine learning, an appropriate action to suppress a future failure can be precisely inferred, making it possible to suppress waste paper. That is, it is possible to suppress a drop in printing quality and productivity. Leaning processing and inference processing in this embodiment will be described below in detail.

### 2. Learning Processing

### 2.1 Example of the Structure of a Learning Apparatus

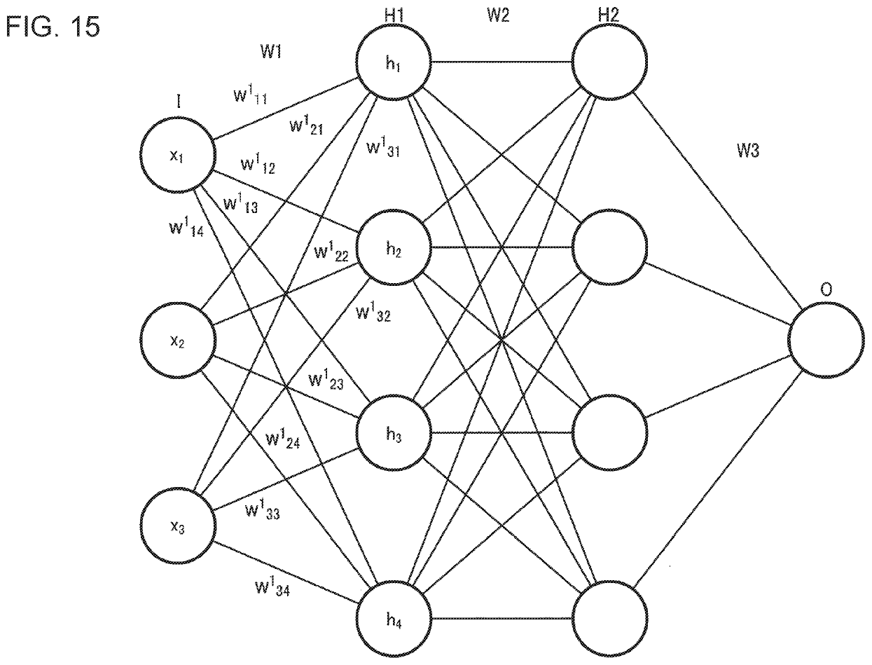

FIG. 14 illustrates an example of the structure of a learning apparatus 400 in this embodiment. The learning apparatus 400 includes an acquiring section 410 that acquires training data used in learning, as well as a learning section 420 that performs learning according to the training data.

The acquiring section 410 is, for example, a communication interface that acquires training data from another apparatus. Alternatively, the acquiring section 410 may acquire training data held in the learning apparatus 400. The learning apparatus 400 includes, for example, a storage (not illustrated), in which case the acquiring section 410 is an interface that reads training data from the storage. Learning in this embodiment is, for example, a supervised learning. Training data in supervised learning is a data set in which input data and correct answer labels are mutually associated.

The learning section 420 performs machine learning based on training data acquired by the acquiring section 410, and creates a machine-learned model. The learning section 420 in this embodiment is structured by hardware described below. The hardware can include at least one of a circuit that processes digital signals and a circuit that processes analog signals. For example, the hardware can be composed of one or plurality of circuit devices mounted on a circuit board or one or a plurality of circuit elements. The one or plurality of circuit devices are, for example, integrated circuits (ICs) or the like. The one or plurality of circuit elements are, for example, resistors, capacitors, and the like.

The learning section 420 may be implemented by a processor described below. The learning apparatus 400 in this embodiment includes a memory that stores information and a processor that operates according to the information stored in the memory. The information is, for example, programs and various types of data. The processor includes hardware. As the processor, a central processing unit (CPU), a graphics processing unit (GPU), a digital signal processor (DSP), or any of other types of processor can be used. The memory may be a semiconductor memory such as a static random access memory (SRAM) or a dynamic random access memory (DRAM), or may be a register. Alternatively, the memory may be a magnetic storage device such as a hard disk unit or an optical storage device such as an optical disk unit. The memory stores, for example, computer-readable instructions. When instructions stored in the memory are executed by the processor, the functions of sections in the learning apparatus 400 are implemented as processing. The instructions referred to here may be instructions in an instruction set constituting a program, or may be instructions that command operations for hardware circuits in the processor. The memory stores, for example, a program that stipulates a learning algorithm. The processor operates according to the algorithm and executes learning processing.

More specifically, the acquiring section 410 acquires failure state information about the print head 31, use environment information about the printing apparatus 1 having print heads 31, and action information representing a recommended action for a failure in the print head 31. The learning section 420 machine-learns an action recommended for a failure according to a data set in which failure state information, use environment information, and action information are associated. Use environment information, which represents an environment in which the printing apparatus 1 is used, includes sensing data such as temperature, information related to the print medium, printing setting information, and the like. Action information identifies an action taken to eliminate a failure in the print head 31. Actions represented by action information include cleaning, nozzle complement, and head replacement as described above. Failure state information, use environment information, and action information will be described later in detail.

According to the method in this embodiment, machine learning is performed by using a data set in which failure state information, use environment information, and action information are associated. Although failure state information directly reflects the state of the print head 31, it is difficult to make highly precise inference from failure state information alone, as described above. In this embodiment, however, various types of information representing factors of failures in the print head 31 are used in machine learning as use environment information. Therefore, it becomes possible to precisely infer an appropriate action to be taken to eliminate a failure by using a learning result. For example, when it is predicted that the degree of a failure may rise in the future, an appropriate action can be taken in advance.

The learning apparatus 400 illustrated in FIG. 14 may be included in, for example, the printing apparatus 1 in FIG. 1. In this case, the learning section 420 corresponds to the controller 100 in the printing apparatus 1. More specifically, the learning section 420 may be the processor 102. The printing apparatus 1 accumulates operation information in the memory 103. Operation information includes printed image information from the first inspection unit 70 or failure state information based on waveform information about residual vibration, the waveform information being transmitted from the second inspection unit 80, as well as sensing data from the detector group 90. The acquiring section 410 may be an interface that reads operation information accumulated in the memory 103. The printing apparatus 1 may transmit the accumulated operation information to an external device such as the computer CP or a server system. The acquiring section 410 may be the interface section 101 that receives training data necessary for learning from the external device.

The learning apparatus 400 may be included in a device other than the printing apparatus 1. For example, the learning apparatus 400 may be included in an external device that collects operation information about the printing apparatus 1 or in another apparatus that can communicate with the external device.

### 2.2 Neural Network

Machine learning in which a neural network is used will be described as a specific example of machine learning. FIG. 15 illustrates an example of the basic structure of a neural network. A neural network is a mathematical model that simulates brain functions on a computer. One circle in FIG. 15 is referred to as a node or neuron. In the example in FIG. 15, the neural network has an input layer, two intermediate layers, and an output layer. The input layer is denoted I, the two intermediate layers are denoted H1 and H2, and the output layer is denoted by O. In the example in FIG. 15, the number of neurons in the input layer is 3, the number of neurons in each intermediate layer is 4, and the number of neurons in the output layer is 1. However, various variations are possible for the number of intermediate layers and the number of neurons included in each layer. Each neuron included in the input layer is joined to the neurons in the intermediate layer H1, referred to below as the first intermediate layer. Each neuron included in the first intermediate layer is joined to the neurons in the intermediate layer H2, referred to below as the second intermediate layer. Each neuron included in the second intermediate layer is joined to the neurons in the output layer. The intermediate layer may also be referred to as the hidden layer.

Each neuron in the input layer outputs an input value. In the example in FIG. 15, the neural network accepts x1, x2, and x3 as an input, after which the neurons in the input layers in the neural network output x1, x2, and x3. Some kind of preprocessing may be performed on input values, and each neuron in the input layer may output a value after preprocessing.

In each neuron in the intermediate layers and subsequent layer, computation is performed that simulates a state in which information is transmitted in the brain as electric signals. In the brain, the ease with which information is transmitted changes depending on the strength of synaptic coupling. In the neural network, therefore, the coupling strength is represented by a weight W. W1 in FIG. 15 is a weight between the input layer and the first intermediate layer. W1 represents a set of weights, each of which is a weight between a given neuron included in the input layer and a given neuron included in the first intermediate layer. When a weight between a p-th neuron in the input layer and a q-th neuron in the first intermediate layer is represented as a weight w¹_{pq}, W1 in FIG. 15 is information including 12 weights w¹₁₁ to w¹₃₄. In a broader sense, the weight W1 is information composed of the same number of weights as the product of the number of neurons in the input layer and the number of neurons in the first intermediate layer.

Computation indicated by equation (1) below is performed in a first neuron in the first intermediate layer. In one neuron, a product is obtained for an output from each neuron in the layer placed immediately before the one neuron and coupled to the one neuron, and such products are summed, after which a bias is added. The bias in equation (1) below is b1.

$${h}_{1} = f ( {\sum }_{i} {w}_{i 1}^{1} \cdot {x}_{i} + {b}_{1} ) \qquad ( 1 )$$

In computation in one neuron, an activation function f, which is a non-linear function, is used as indicted by equation (1) above. A ReLU function indicated by equation (2) below, for example, is used as an activation function f. A ReLU function takes 0 when a variable is 0 or smaller, and takes the value of the variable itself when the variable is larger than 0. However, it is known that any of other various functions can be used as an activation function f. A sigmoid function may be used or an improved function of a ReLU function may be used. Equation (1) above is an example of a computation equation for h1. Computation can be similarly performed for other neurons in the first intermediate layer as well.

$$f ( x ) = max ( 0 , x ) = \{ \begin{matrix}0 & ( x \leq 0 ) \\ x & ( x \geq 0 )\end{matrix} \qquad ( 2 )$$

The above similarly applies to the subsequent layer as well. For example, a weight between the first intermediate layer and the second intermediate layer is assumed to be W2. Then, in computation in the neurons in the second intermediate layer, an activation function is applied by using outputs from the first intermediate layer and the weight W2 to perform multiply-and-accumulation and then adding a bias. In computation in the neurons in the output layer, weighted addition is performed for outputs from the layer immediately before the output layer and then a bias is added. In the example in FIG. 15, the layer immediately before the output layer is the second intermediate layer. In the neural network, a computation result in the output layer is an output from the neural network.

As seen from the above description, to obtain a desired output from inputs, a weight and bias need to be appropriately set. In the description below, a weight will also be referred to as a weighting coefficient. A bias may be included in a weighting coefficient. In learning, a data set in which a given input x and a correct output for the input are mutually associated is prepared. A correct output is a correct answer label. Learning processing in a neural network can be thought as processing to obtain the most probable weighting coefficient according to the data set. In learning processing in a neural network, various learning methods such as backpropagation are known. In this embodiment, these learning methods can be widely applied, so detailed description will be omitted. A learning algorithm employed when a neural network is used is, for example, an algorithm in which both processing to acquire a forward result by performing computation as in equation (1) above or the like and processing to update weighting coefficient information by using backpropagation are performed.

A neural network is not limited to the structure illustrated in FIG. 15. For example, a convolutional neural network (CNN), which is widely known in learning processing in this embodiment and inference processing described later, may be used. A CNN has a convolutional layer and a pooling layer. In the convolutional layer, convolutional computation is performed. The convolutional computation referred to here is specifically filer processing. In the pooling layer, processing to reduce the vertical and horizontal sizes of data is performed. In the CNN, when learning processing in which backpropagation or the like is used is performed, the property of a filter used in convolutional computation is learned. That is, the weighting coefficient in a neural network includes the filer property in the CNN. A network having another structure such as a recurrent neural network (RNN) may be used as a neural network.

So far, an example in which a machine-learned model is a model that uses a neural network has been described. However, machine learning in this embodiment is not limited to a method in which a neural network is used. For example, machine learning in widely known various other methods such as a support vector machine (SVM) or machining learning in methods developed from these methods can be applied as the method in this embodiment.

### 2.3 Examples of Training Data and Details of Learning Processing

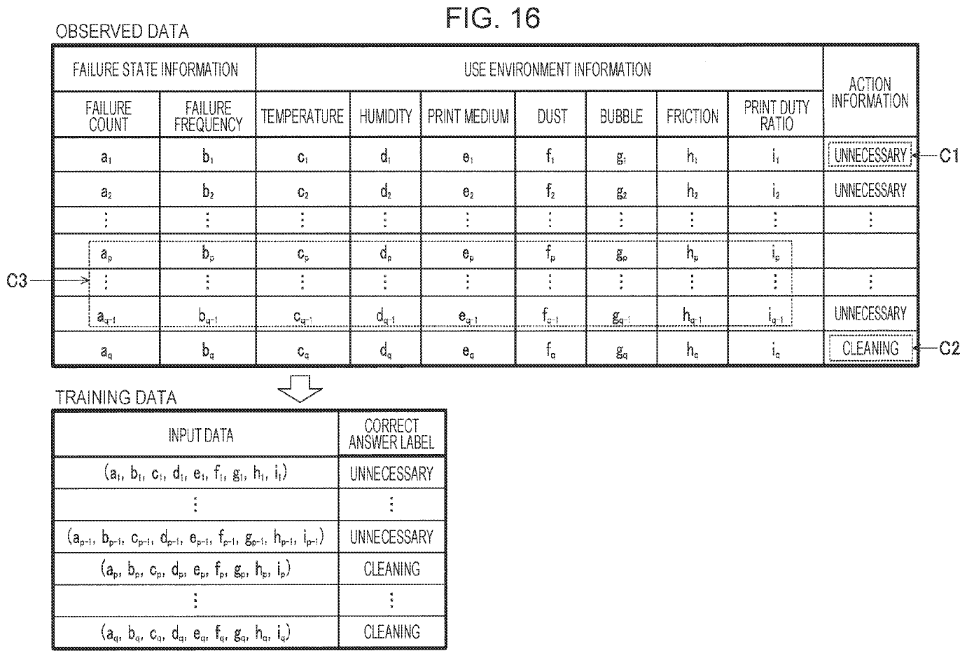

FIG. 16 indicates observed data acquired in the printing apparatus 1 and training data acquired according to the observed data. The observed data includes failure state information, use environment information, and action information. In FIG. 16, the letter p is a natural number larger than 1 and the letter q is a natural number lager than p.

As illustrated in FIG. 16, failure state information is comprised of failure count information about the nozzles Nz included in the print head 31 and failure frequency information about the nozzles Nz. When failure state information is used, machine learning in which the state of the print head 31 at each timing is considered is possible.

For example, failure state information is obtained according to waveform information about residual vibration. The printing apparatus 1 acquires waveform information in a period, for example, between pages or between paths during a print operation. When to-be-printed data is managed on a per-page basis, a period between pages refers to a period from when the printing of a given page is completed until the printing of a next page starts. In a printer in a serial head method, a period between paths refers to a period from when a forward movement of the carriage 21 is completed until its backward movement starts. Alternatively, a period between paths may be a period from when a bidirectional movement is completed until a next bidirectional movement starts. However, the above is not a limitation on timings at which to acquire waveform information. Various variations are possible. According to waveform about each nozzle Nz, the second inspection unit 80 decides whether there is a failure.

When decisions about waveform information are made for all nozzles Nz in the period between pages or between paths, the number of nozzles Nz having a failure, that is, the failure count, is obtained. Failure state information is an integer that is, for example, equal to or greater than 0 and equal to or smaller than the total number of nozzles Nz.

The printing apparatus 1 sets a given decision period longer than a decision interval between pages or between paths. In the given decision period, a plurality of failure detections based on waveform information are made. The printing apparatus 1 counts the number of times the failure count was decided to be equal to or larger than a predetermined threshold in the given decision period to obtain failure frequency information. Failure frequency information represents the number of times a failure occurred in, for example, one hour. The predetermined threshold may be 1 or another positive integer.

Use environment information includes information related to a print medium. Information related to a print medium is, for example, information that identifies the type of a print medium. When a contact is made between the print head 31 and a print medium, foreign matter may adhere to a nozzle Nz as illustrated in FIG. 10. Foreign matter referred to here is specifically paper dust, which is part of a print medium, or the like. The degree at which a print medium is likely to become fluffy or to generate paper dust depends on the type of the print medium. That is, the type of the print medium is a factor that affects the generation of a failure in the print head 31. The type of the print medium is a factor that increases both failure count and failure frequency information.

Use environment information includes information detected by sensors included in the printing apparatus 1. Thus, sensing data representing the use situation of a print medium can be used in machine learning. Specific constituent sensors are not limited to sensors described below. Various modifications are possible.

A sensor referred to here is, for example, the bubble sensor 95 that detects a bubble in ink to be discharged from the print head 31. As illustrated in FIG. 8, a bubble concerns a failure in the print head 31. When the bubble sensor 95 is used, information representing a factor of a failure can be used as use environment information. The bubble sensor 95 is, for example, an ultrasonic sensor. A bubble has a lower efficiency at which a supersonic wave propagates than ink, which is a liquid. When a bubble is present, therefore, an intensity with which the supersonic wave is received is lowered. Bubble information, which is an output from the bubble sensor 95, may be information about reception intensity or may be a result in some kind of editing processing.

A sensor included in the printing apparatus 1 may be the dust sensor 96. In a dusty environment, the nozzle Nz is likely to be clogged, so the print head 31 is likely to cause a failure. When the dust sensor 96 is used, information representing a factor of a failure can be used as use environment information. The dust sensor 96, which is desirably a sensor that detects the amount of dust around the print head 31, is attached to, for example, the print head 31. However, the dust sensor 96 may be attached to another position on the printing apparatus 1.

The dust sensor 96 is specifically a particle counter. The dust sensor 96 includes a light emitting element and a light receiving element. The light receiving element is disposed, for example, at a position at which the light receiving element does not receive light directly from the light emitting element. When dust is not present, the intensity of light received at the light receiving element is low. When dust is present, the received light intensity is high because the light receiving element receives light reflected from the dust. The dust sensor 96 detects the size of a dust particle and the number of dust particles according to the received light intensity. Although, dust information in this embodiment is, for example, information representing the number of dust particles, information in another form may be used.

A sensor included in the printing apparatus 1 is the friction sensor 97 that detects friction between the print head 31 and the print medium. When strong friction occurs between the print head 31 and the print medium, foreign matter such as paper dust is likely to adhere to a nozzle Nz. When, for example, a fluffy print medium rubs on the print head 31, failures may occur in many nozzles Nz. When the friction sensor 97 is used, information representing a factor of a failure can be used as use environment information.

The friction sensor 97 is, for example, a proximity sensor of capacitive type. The proximity sensor includes, for example, a charged object and a detection electrode. The proximity sensor outputs a signal with a potential matching the distance between the charged object and the detection electrode. When the proximity sensor is used, the distance between a given position on the print head 31 and a given position on the print medium can be inferred, so a friction intensity can be detected.

Some sensors included in the printing apparatus 1 are environment sensors. The environment sensors are, for example, the temperature sensor 91, humidity sensor 92, and atmospheric pressure sensor 93. When temperature changes, the viscosity of ink changes. Therefore, temperature is information representing a factor of an increase in the viscosity of ink illustrated in FIG. 9. Humidity affects the surface potential of the print head 31 and the property of ink. When atmospheric pressure changes, a relationship between external pressure and pressure in the pressure chamber 331 of the print head 31 is changes. Therefore, a change in atmospheric pressure affects the discharge of ink from the nozzle Nz. Thus, environmental parameters such as temperature, humidity, and atmospheric pressure are information representing failures in the print head 31.

The use environment information includes print setting information. Print setting information includes information that determines a print speed, information that determines whether printing is color printing or monochrome printing, and the like. Print setting information determines how ink is discharged from the print head 31. Since print setting information represents a specific usage of the print head 31, therefore, print setting information is useful for predicating a failure in the print head 31.

Specifically, print setting information may be a print duty ratio. The print duty ratio is information representing a ratio of an area occupied by printed characters to the area of a print sheet. When the print duty ratio is high, ink mists are likely to be generated and ink is thereby likely to adhere to the surface of the print head 31, leading to a discharge failure. In some cases, a flying curve, which is a failure that prevents ink discharged from the nozzle Nz from landing straight on the print medium, or the like may occur.

As described above, when failure state information is used, the state of the print head 31 at that time can be inferred. When use environment information is used, various factors involved in failures in the print head 31 can be considered. By combining failure state information and use environment information together, it becomes possible to predict a future failure and determine an appropriate action to suppress the failure.

At a learning stage, it is necessary to associate information used as a correct answer label, that is, information indicating a desirable action, with failure state information and use environment information. Therefore, the acquiring section 410 acquires a data set in which failure state information, use environment information, and action information are associated.

An action represented by action information may be, for example, any one of “cleaning”, “nozzle complement”, “head replacement”, and “unnecessary” as described above. Action information is, for example, information obtained according to failure state information and use environment information. For example, “unnecessary” indicated by C1 in FIG. 16 is obtained according to a₁ representing the failure count and b₁ representing a failure frequency. Here, a point representing (a₁, b₁) is plotted in the area A1 in FIG. 12, so action information represents “unnecessary”.

Action information in observed data in FIG. 16 represents an action recommended at a timing corresponding to a timing at which failure state information and use environment information are acquired. When, in machine learning, failure state information is used as an input and action information itself is used as a correct answer label, a machine-learned model that outputs an action recommended for an already generated failure is acquired. In this case, waster paper cannot be suppressed. When action information is obtained from failure state information, the significance of using use environment information is reduced.

In this embodiment, therefore, training data is created by performing editing processing on action information according to time-series observed data. Action information in this embodiment includes information as well that has been subjected to editing processing.

First, at each timing, failure state information, use environment information, and action information are acquired to acquire observed data, as described above. In FIG. 16, as, s being an integer equal to larger than 1, is failure count information acquired a timing before aₛ₊₁. This is also true for other information such as failure frequency information. That is, each type of information in observed information in FIG. 16 is time-series information acquired in the order from top to bottom.

In the example in FIG. 16, at the timing indicated by C2, a shift occurred from a state in which no action had been needed to a state in which cleaning is recommended. For example, this is equivalent to a case in which although points (a₁, b₁) to (a_{q-1}, b_{q-1}) had been plotted in the area A1 in FIG. 12, the point (a_{q}, b_{q}) has been plotted in the area A3 in FIG. 12. To suppress waste paper, it is necessary to suggest the practice of cleaning at a timing before C2. As described above, it is difficult to infer (a_{q}, b_{q}) with high precision according to (a₁, b₁) to (a_{q-1}, b_{q-1}). In this embodiment, however, use environment information related to failures in the print head 31 has been acquired. It is thought be possible to predict at a timing before C2 that cleaning is needed.

The range indicated by C3 in FIG. 16 is equivalent to, for example, a period in which when cleaning is not performed within a predetermined time, the failure count will exceed Th2 and waste paper will thereby be generated. Therefore, it is inferred that a sign of a failure that needs cleaning appears in failure state information and use environment information in the range indicated by C3. In view of this, the learning section 420 changes action information in the range indicated by C3 to “cleaning” as illustrated in FIG. 16, and creates training data. Training data in this embodiment is a data set in which failure state information and use environment information are used as input data and action information that has been subjected to editing processing is used as a correct answer label. Then, at a stage at which a failure that needs an action has not occurred at that time as indicated by C3, action information that help suppress a future failure can be output.

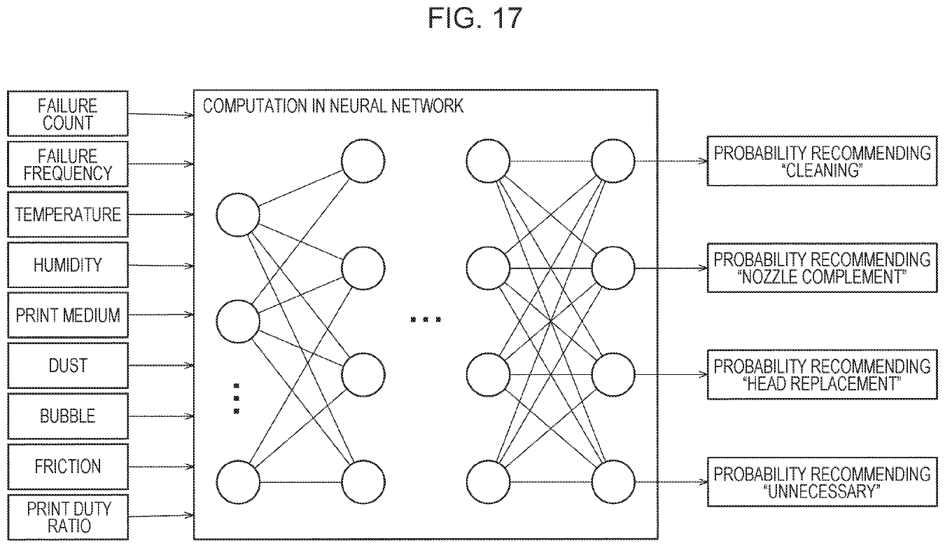

FIG. 17 illustrates an example of a model of a neural network in this embodiment. The neural network accepts failure state information and use environment information as an input, and outputs information representing a recommended action as output data. Information representing an action is specifically information that represents whether the recommended action is “cleaning”, “nozzle complement”, “head replacement”, or “unnecessary”. The output layer in the neural network may be a widely known softmax layer. In this case, the neural network produces four outputs, probability data representing “cleaning”, probability data representing “nozzle complement”, probability data representing “head replacement”, and probability data representing “unnecessary”.

Learning processing based on, for example, training data in FIG. 16 is performed according to a flow described below. First, the learning section 420 enters input data to the neural network, after which the learning section 420 performs a forward computation by using a weight at that time to acquire output data. When training data in FIG. 16 is used, input data is failure state information and use environment information. Output data obtained by the forward computation is composed of four pieces of probability data, the total sum of which is 1, as described above.

The learning section 420 performs a computation of an error function according to the obtained output data and a correct answer label. When training data in FIG. 16 is used, for example, the correct answer label is information in which the value of the corresponding probability data is 1 and the values of the other three pieces of probability data are 0. When “cleaning”, for example, is assigned, a specific correct answer label is information in which the value of probability data indicating “cleaning” is 1 and the total of three values of probability data indicating “nozzle complement” probability data indicating “head replacement”, and probability data indicating “unnecessary” is 0.

The learning section 420 calculates, as an error function, the degree of a difference between four pieces of probability data obtained in the forward computation and four pieces of probability data corresponding to correct answer labels, and updates weighting coefficient information in such a way that error is reduced. Error functions in various forms are known. In this embodiment, these error functions can be widely applied. Although backpropagation, for example, is used to update weighting coefficient information, another method may be used.

So far, learning processing based on one piece of training data has been outlined. The learning section 420 repeats similar processing on other training data, and learns appropriate weighting coefficient information. For example, the learning section 420 uses part of acquired data as training data, and also uses the rest as test data. Test data can also be referred to as evaluation data or verification data. The learning section 420 applies test data to a machine-learned model created from training data, and continues learning until a correct answer rate reaches at least a predetermined threshold.

In learning processing, it is known that the more the number of pieces of training data is increased, the more precision is improved. FIG. 16 exemplifies observed data acquired before action information representing “cleaning” is acquired once. However, it is desirable to prepare much more training data by continuing to acquire observed data even after the execution of an action.

### 2.4 Variations

In a broad sense, the method indicted in FIG. 16 is a method by which failure state information and use environment information are associated with action information about a future failure. Action information may be obtained according to failure state information as described above, in which case action information can be expanded to failure state information itself. In view of this, the machine-learned model in this embodiment may be a model that predicts failure state information about a future failure according to failure state information and use environment information at a given timing. For example, training data in this embodiment is a data set in which a₁ to i₁ are used as an input and failure state information such as, for example, a₂ and b₂ a at a timing later than the timing corresponding to a₁ to i₁ are used as correct answer labels. An input is not limited to failure state information and use environment information at one timing. An input may be history information including information at a plurality of timings, in which case the neural network accepts actually measured failure state information and use environment information as an input and outputs a predicted value for the failure state information. When failure state information about a future failure can be predicted, a correct action can be inferred according to the predicted failure state information. Thus, when action information is obtained from failure state information, various variations are possible for training data and the structure of the neural network.

Action information is not limited to information obtained from failure state information. For example, action information may be information entered by a serviceman or another user. An information collecting system can be considered that includes a plurality of printing apparatuses 1 and a server system that collects operation information from the plurality of printing apparatuses 1, as described above. This information collecting system may include a terminal apparatus used by a serviceman. The server system may acquire information about an action that has been taken for the printing apparatus 1. Actions taken by the serviceman include cleaning in the interior of the printing apparatus 1 and the like besides cleaning and head replacement. Enhanced cleaning and other actions executable only by users having a right such as a serviceman may also be performed.

Servicemen, who are skilled workers, can determine an appropriate action according to the state of the printing apparatus 1. Therefore, when actions taken by servicemen are machine-learned, an appropriate action can be inferred. In this case as well, when an action is taken by a serviceman at a given timing, action information representing the action is associated with failure state information and use environment information at a timing before the given timing as a correct answer label, as in, for example, the example in FIG. 16.

When failure state information is not used in the determination of action information, any one of failure count information and failure frequency information may be eliminated from failure state information. The method in this embodiment is to predict an appropriate action according to a combination of failure state information and use environment information, and is not to predict an action to be taken in the future only from failure state information. When a variety of information can be used as use environment information, therefore, even when any one of failure count information and failure frequency information is eliminated, it is still possible to predict a failure in the future and infer an appropriate action for the failure with adequate precision. Failure state information only needs to represent the degree of a failure in the print head 31, so information different from failure count information and failure frequency information may be added to failure state information.

### 3. Inference Processing

### 3.1 Example of the Structure of an Information Processing Apparatus

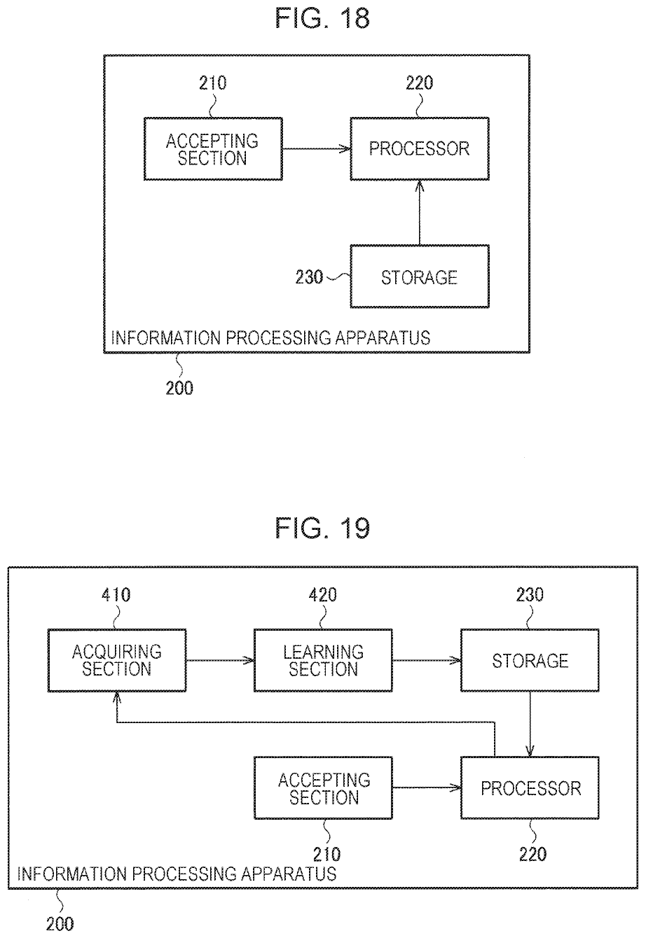

FIG. 18 illustrates an example of the structure of an inference apparatus in this embodiment. The inference apparatus is an information processing apparatus 200. The information processing apparatus 200 includes an accepting section 210, a processor 220, and a storage 230.

The storage 230 stores a machine-learned model in which machine learning has been performed according to a data set in which failure state information, use environment information, and action information are associated. The accepting section 210 accepts failure state information and use environment information as an input. The processor 220 suggests an action recommended for a failure in the print head 31, according to the machine-learned model and the failure state information and use environment information accepted as an input.

As described above, a failure in the print head 31 is largely affected by the use environment. When use environment information is used besides failure state information representing the actual state of the print head 31, an action to suppress a future failure can be precisely inferred. This makes it possible to suppress waste paper generated by a failure in the print head 31.

A machine-learned model is used as a program module, which is part of artificial-intelligence software. The processor 220 outputs data representing an action matching failure state information and use environment information, which are an input, in response to a command from the machine-learned model stored in the storage 230.

The processor 220 in the information processing apparatus 200 is composed of hardware that includes at least one of a circuit that processes digital signals and a circuit that processes analog signals, as with the learning section 420 in the learning apparatus 400. The processor 220 may be implemented by a processor describe below. The information processing apparatus 200 in this embodiment includes a memory that stores information and a processor that operates according to the information stored in the memory. As the processor, a CPU, a GPU, a DSP, or any of other types of processors can be used. The memory may be a semiconductor memory, a register, a magnetic storage device, or an optical storage device. The memory referred to here is, for example, the storage 230. That is, the storage 230 is an information storage medium such as a semiconductor memory, and a program such as a machine-learned model is stored in the information storage medium.

Computation performed in the processor 220 according to a machine-learned model, that is, computation to produce output data according to input data, may be executed by software or may be executed by hardware. In other words, multiply and accumulation in equation (1) above or the like may be executed by software. Alternatively, the above computation may be executed by a circuit device such as a field-programmable gate array (FPGA) or may be executed by a combination of software and hardware. Thus, the processor 220 can operate in various aspects in response to a command from the machine-learned model stored in the storage 230. For example, the machine-learned model includes an inference algorithm and parameters used in the inference algorithm. The inference algorithm performs, for example, multiply and accumulation in equation (1) above according to input data. The parameters, which are acquired through learning processing, include, for example, weighting coefficient information. In this case, the inference algorithm and parameters may be both stored in the storage 230. Then, the processor 220 may read the inference algorithm and parameters and may perform inference algorithm by software. Alternatively, the inference algorithm may be implemented by an FPGA or the like, and the storage 230 may store the parameters.

The information processing apparatus 200 in FIG. 18 is included in the printing apparatus 1 illustrated in, for example, FIG. 1. That is, the method in this method can be applied to the printing apparatus 1 including the information processing apparatus 200. In this case, the processor 220 corresponds to the controller 100 in the printing apparatus 1 and, in a narrow sense, to the processor 102. The storage 230 corresponds to the memory 103 in the printing apparatus 1. The accepting section 210 corresponds to an interface that reads failure state information and use environment information accumulated in the memory 103. The printing apparatus 1 may transmit accumulated operation information to an external device such as a computer CP or server system. The accepting section 210 may be the interface section 101 that receives, from the external device, failure state information and use environment information required for inference. However, the information processing apparatus 200 may be included in a device other than the printing apparatus 1. For example, the information processing apparatus 200 is included in an external device such as a server system that collects operation information from a plurality of printing apparatuses 1. The external device performs processing to infer a recommended action for each printing apparatus 1 according to the collected operation information, and performs processing to transmit, to the printing apparatus 1, information that suggests the action.

In the description above, the learning apparatus 400 and information processing apparatus 200 have been separated. However, this is not a limitation on the method in this embodiment. For example, as illustrated in FIG. 19, the information processing apparatus 200 may include the acquiring section 410 that acquires a data set in which failure state information, use environment information, and action information are associated, as well as the learning section 420 that machine-learns an action recommended for a failure in the printing apparatus 1 according to the data set. In other words, in addition to the structure in FIG. 18, the information processing apparatus 200 includes a structure corresponding to the learning apparatus 400 in FIG. 14. Thus, it becomes possible to efficiently execute both learning processing and inference processing in a single apparatus.

Processing performed by the information processing apparatus 200 in this embodiment may be implemented as an information processing method. In the information processing method, a machine-learned model is acquired and failure state information and use environment information are accepted from the printing apparatus 1 having print heads 31, after which an action recommended for a failure is suggested according to the machine-learned model and the accepted failure state information and use environment information. In the machine-learned model referred to here, machine learning has been performed according to a data set in which failure state information about the print head 31 that discharges ink, use environment information about the printing apparatus 1 having the print head 31, and action information representing an action recommended for a failure in the print head 31 are associated, as described above.

### 3.2 Flow in Inference Processing

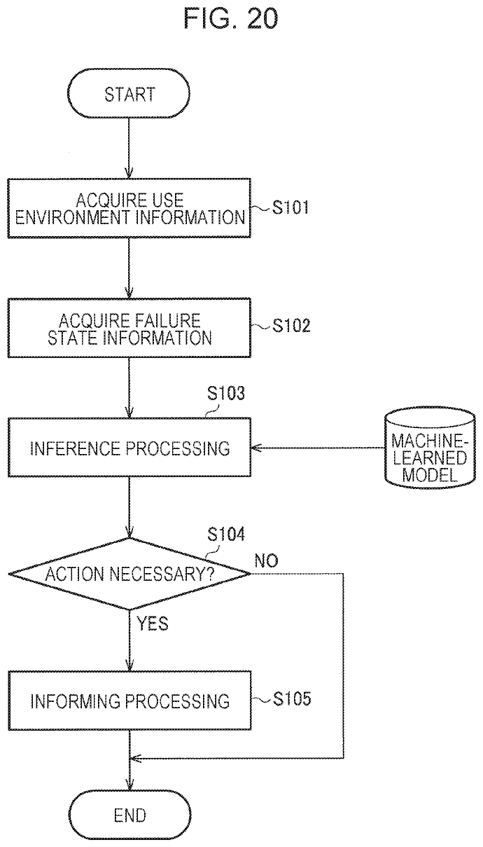

FIG. 20 is a flowchart illustrating processing in the information processing apparatus 200. When this processing starts, the accepting section 210 acquires failure state information and use environment information first (S101 and S102). Then, the processor 220 performs processing to infer a recommended action according to the acquired failure state information and use environment information and to the machine-learned model stored in the storage 230 (S103). When the neural network illustrated in FIG. 17 is used, in processing in S103, four pieces of probability data representing “cleaning”, “nozzle complement”, “head replacement”, and “unnecessary” are obtained, after which the maximum value is identified from the four pieces of probability data. In processing in S103, the processor 220 may also perform processing to obtain a predicted value for failure state information according to the acquired failure state information and use environment information and to the machine-learned model stored in the storage 230. In this case, to determine a recommended action, the processor 220 performs processing to determine an area, which is one of A1 to A4 illustrated in FIG. 12, in which a point representing the predicted failure count information and failure frequency information is plotted.

Next, the processor 220 decides whether an action is necessary (S104). When “unnecessary” is determined in S103 or the point representing the predicted failure count information and failure frequency information is plotted in the area A1, the processor 220 decides that no action is necessary (No in S104) and terminates the processing. Otherwise, the processor 220 decides that an action is necessary (Yes in S104) and performs informing processing to suggest a specific action to the user (S105).

For example, the processor 220 performs processing to recommend execution of nozzle complement processing as an action. When, for example, the probability of “nozzle complement” is highest in S103, the processor 220 performs informing processing to suggest nozzle complement processing as an action. The processor 220 may also perform processing to recommend execution of cleaning or head replacement as an action. When, for example, the probability of “cleaning” is highest in S103, the processor 220 performs informing processing to suggest cleaning as an action. When the probability of “head replacement” is highest in S103, the processor 220 performs informing processing to suggest head replacement as an action.

Thus, it becomes possible to suggest an appropriate action matching the predicted state of a failure in the print head 31. Then, it becomes possible to suppress a future failure and to suppress waste paper. The processor 220 may suggest another action such as wiping, flushing, or cleaning in the interior of the printing apparatus 1.

Informing processing referred to here is processing to display a screen suggesting an action or a screen prompting the user to execute an action on the display section (not illustrated) of the printing apparatus 1 or the display section of a computer CP. However, informing processing is not limited to the displaying of a screen, but may be processing to cause a light emitting section such as a light emitting diode (LED) to emit light or processing to output a warning sound or a voice from a speaker. The device on which suggestion processing is performed is not limited to the printing apparatus 1 or a computer CP. The device may be a mobile terminal that the user uses or another device.

When processing illustrated in FIG. 20 is periodically executed, a future failure is suppressed and stable printing can thereby be executed in the printing apparatus 1.

### 4. Additional Learning

In this embodiment, the learning stage and inference stage may be clearly distinguished from each other. For example, learning processing has been performed in advance by, for example, the manufacturer of the printing apparatus 1, and a machine-learned model is stored in the memory 103 in the printing apparatus 1 at the time of shipping of the printing apparatus 1. At the stage at which the printing apparatus 1 is used, the stored machine-learned model is fixedly used.

However, the above is not a limitation on the method in this embodiment. Learning processing in this embodiment may include initial learning to create an initial machine-learned model and additional learning to update the machine-learned model. An initial machine-learned model is, for example, a general-purpose machine-learned model stored in the printing apparatus 1 in advance before shipping as described above. Additional learning is, for example, learning processing to update the machine-learned model according to the usage situation of the individual user.

Additional learning may be executed in the learning apparatus 400. The learning apparatus 400 may be an apparatus different from the information processing apparatus 200. However, the information processing apparatus 200 performs processing to acquire failure state information and use environment information for the sake of inference processing. The failure state information and use environment information can be used as part of training data in additional learning. In view of this, additional learning may be performed in the information processing apparatus 200. Specifically, the information processing apparatus 200 includes the acquiring section 410 and learning section 420 as illustrated in FIG. 19. The acquiring section 410 acquires failure state information and use environment information. For example, the acquiring section 410 acquires information that the accepting section 210 has received in S101 and S102 in FIG. 20. The learning section 420 updates a machine-learned model according to a data set in which action information is associated with failure state information and use environment information.

The action information referred to here is specifically information representing an action determined according to failure count information and failure frequency information. Thus, training data equivalent to observed data in FIG. 16 can be accumulated in the printing apparatus 1 while it is operating. Conversion from observed data to training data is ease as illustrated in FIG. 16.

Action information may be information entered by a serviceman or another user, as described above, in which case, the information processing apparatus 200 accumulates failure state information and use environment information in advance. When a serviceman has taken an action for the targeted printing apparatus 1, the information processing apparatus 200 assign a correct answer label corresponding to the taken action to the failure state information and use environment information to create training data. When, for example, the information processing apparatus 200 periodically asks a server system in an operation information collecting system, whether a serviceman has taken an action can be decided. Alternatively, when action information is entered, the server system may transmit a push notification to the information processing apparatus 200.

The flow of additional learning processing after training data has been acquired is similar the flow of learning processing described above, so detailed descriptions will be omitted.

As described above, an information processing apparatus in this embodiment includes a storage that stores a machine-learned model, an accepting section, and a processor. In the machine-learned model, machine learning has been performed according to a data set in which failure state information about a print head, use environment information about a printing apparatus having the print head, and action information representing an action matching a failure in the print head are associated. The accepting section accepts the failure state information about the print head and the use environment information. The processor suggests an action matching the failure according to the machine-learned model and the accepted failure state information and use environment information.

According to the method in this embodiment, an action is suggested for a failure according to a machine-learned model, which is a result obtained by machine-learning a relationship among failure state information, use environment information, and action information. When machine learning is performed with a use environment taken into consideration, an action appropriate to eliminate a failure can be precisely inferred.

The failure state information may be at least one of failure count information about the nozzles included in the print head and failure frequency information about the nozzles.

Accordingly, it becomes possible to make a decision about a print head failure by using a failure count or a failure frequency as an index.

The use environment information may include information related to a print medium.

Accordingly, it becomes possible to infer an appropriate action in consideration of, for example, the ease, depending on the print medium, with which a failure occurs and the type of a failure that is likely to occur.

The use environment information may include information detected by a sensor included in the printing apparatus.

Accordingly, it becomes possible to infer an appropriate action according to the result obtained by sensing the environment of the printing apparatus.

Sensors may include at least one of a bubble sensor that detects a bubble in ink to be discharged from the print head, a dust sensor, a friction sensor that detects a friction between the print head and the print medium, and an environment sensor.

Accordingly, it becomes possible to infer an appropriate action according to an environment factor related to a failure in the print head.

The use environment information may include print setting information.

Accordingly, it becomes possible to infer an appropriate action according to information that stipulates a specific print operation.

The processor may recommend nozzle complement processing as the action.

Accordingly, it becomes possible to continue printing by performing nozzle complement.

The processor may recommend the cleaning of the print head or the replacement of the print head as the action.

Accordingly, it becomes possible to suggest an action by which a failure can be eliminated.

The information processing apparatus may include an acquiring section that acquires the data set in which the failure state information, use environment information, and the action information are associated, as well as a learning section that machine-learns the action matching the failure according to the acquired data set.

Accordingly, it becomes possible to execute learning in the information processing apparatus.

A printing apparatus in this embodiment includes the information processing apparatus and print head that have been described above.

A learning apparatus in this embodiment has an acquiring section and a learning section. The acquiring section acquires a data set in which failure state information about a print head, use environment information about a printing apparatus having the print head, and action information representing an action matching a failure in the print head are associated. The learning section machine-learns the action matching the failure in the print head according to the acquired data set.

According to the method in this embodiment, a relationship among failure state information, use environment information, and action information is machine-learned. When machine learning is performed with a use environment taken into consideration, an action appropriate to eliminate a failure can be precisely inferred.

An information processing method in this embodiment is a method in which a machine-learned model is acquired, failure state information about a print head and use environment information are accepted, and an action matching a failure is suggested according to the failure state information, use environment information, and machine-learned model. In the machine-learned model, machine learning has been performed according to a data set in which the failure state information about the print head, the use environment information about a printing apparatus having the print head, and action information representing an action matching the failure in the print head are associated.

So far, this embodiment has been described in detail. However, it will be understood by those skilled in the art that many variations are possible without substantively departing from the novel items and effects in this embodiment. Therefore, these variations are all included in the range of the present disclosure. For example, when a term is described at least once in the specification or the drawings together with a different term that has a broader sense than the term or is synonymous with the term, the term can be replaced with the different term at any portion in the specification or the drawings. All combinations of this embodiment and its modifications are also included in the range of the present disclosure. Various modifications are possible for the structures, operations, and the like of the learning apparatus, the information processing apparatus, and the system including these apparatuses, without being limited to those described in this embodiment.

What is claimed is:

1. An information processing apparatus comprising:
a storage that stores a machine-learned model in which machine learning was performed according to a data set in which failure state information about a print head, use environment information about a printing apparatus having the print head, and action information representing an action matching a failure in the print head are associated;
an accepting section that accepts the failure state information about the print head and the use environment information; and
a processor that suggests an action matching the failure according to the machine-learned model and to the failure state information and the use environment information that were accepted.

2. The information processing apparatus according to claim 1, wherein the failure state information is at least one of failure count information about a nozzle included in the print head and failure frequency information about the nozzle.

3. The information processing apparatus according to claim 1, wherein the use environment information includes information related to a print medium.

4. The information processing apparatus according to claim 1, wherein the use environment information includes information detected by a sensor included in the printing apparatus.

5. The information processing apparatus according to claim 4, wherein sensors, one of which is the sensor, includes at least one of a bubble sensor that detects a bubble in an ink to be discharged from the print head, a dust sensor, a friction sensor that detects a friction between the print head and the print medium, and an environment sensor.

6. The information processing apparatus according to claim 1, wherein the use environment information includes print setting information.

7. The information processing apparatus according to claim 1, wherein the processor recommends nozzle complement processing as the action.

8. The information processing apparatus according to claim 1, wherein the processor recommends cleaning of the print head or replacement of the print head as the action.

9. The information processing apparatus according to claim 1, further comprising:
an acquiring section that acquires the data set in which the failure state information, the use environment information, and the action information are associated; and
a learning section that machine-learns the action matching the failure according to the data set that was acquired.

10. A printing apparatus comprising:
the information processing apparatus according to claim 1; and
the print head.

11. A learning apparatus comprising:
an acquiring section that acquires a data set in which failure state information about a print head, use environment information about a printing apparatus having the print head, and action information representing an action matching a failure in the print head are associated; and
a learning section that machine-learns the action matching the failure in the print head according to the data set that was acquired.

12. An information processing method comprising:
acquiring a machine-learned model in which machine learning was performed according to a data set in which failure state information about a print head, use environment information about a printing apparatus having the print head, and action information representing an action matching a failure in the print head are associated;
accepting the failure state information about the print head and the use environment information; and
suggesting an action matching the failure according to the failure state information, the use environment information, and the machine-learned model.
